(19) United States
(12) Patent Application Publication
(10) Pub. No.: US 2025/0003515 A1
(43) Pub. Date: Jan. 2, 2025

(54) CONTROL VALVE

(71) Applicant: YAMADA MANUFACTURING CO., LTD., Kiryu-shi, Gunma (JP)

(72) Inventor: Akifumi Ozeki, Kiryu-shi (JP)

(21) Appl. No.: 18/709,156

(22) PCT Filed: Nov. 18, 2022
(86) PCT No.: PCT/JP2022/042893

§ 371 Date: May 10, 2024

(30) Foreign Application Priority Data
Dec. 13, 2021 (JP) 2021-201628

(51) Int. Cl. F16K 27/02

(52) U.S. Cl. CPC F16K 27/0209

(57) ABSTRACT

A control valve including: a casing having an inflow port through which a fluid flows in from an outside and an outflow port through which the fluid flows out to the outside; and a rotor having a bottomed tubular valve body forming an internal space through which the fluid flows, the rotor being accommodated inside the casing to be rotatable around an axis of the valve body. The rotor switches communication and cutoff between the internal space and at least one of the inflow and outflow ports through a communication port according to a rotation position of the valve body. The casing includes an axial support portion that rotatably supports the valve body via a bottom portion of the valve body, with the axial support portion in sliding contact with the bottom portion from an outer side of the valve body in the axial direction of the valve body.

### TECHNICAL FIELD

The present disclosure relates to a control valve.

Priority is claimed on Japanese Patent Application No. 2021-201628, filed on Dec. 13, 2021, the content of which is incorporated herein by reference.

### BACKGROUND ART

A vehicle is equipped with a cooling system that cools a heat generating portion (for example, an engine, a motor, or the like) by using cooling water circulating between the heat generating portion and a heat dissipating portion (for example, a radiator, a heater, or the like). In the cooling system, a control valve is provided on a flow path connecting the heat generating portion and the heat dissipating portion to each other, thereby controlling the flowing of the cooling water.

As the control valve, for example, Patent Document 1 below discloses a configuration in which a casing having an outflow port for cooling water, and a bottomed tubular rotor configured to rotate inside the casing are provided. A communication port that allows an inner space of the rotor and the outflow port to communicate with each other in response to rotation of the rotor is formed in a tubular portion of the rotor.

According to this configuration, by rotating the rotor, communication and cutoff between the outflow port and the communication port can be switched. The cooling water that has flowed into the control valve flows into the inner space of the rotor and then flows out from the control valve through the outflow port that is in a communication state with the communication port. As a result, the cooling water that has flowed into the control valve is distributed to the desired heat dissipating portion in response to the rotation of the rotor.

### CITATION LIST

### Patent Document

### Patent Document 1

Japanese Unexamined Patent Application, First Publication No. 2020-197305

### SUMMARY OF INVENTION

### Technical Problem

In the related art, the rotor is rotatably supported in the axial direction by the casing through a thrust bearing provided between a bottom portion of the rotor and the casing. Therefore, in the control valve according to the related art, there is still room for improvement in achieving a reduction in the number of components. In the control valve according to the related art, there is still room for improvement in achieving a reduction in size because it is necessary to provide a location in the casing to hold the thrust bearing.

The present disclosure provides a control valve that can achieve a reduction in size and a reduction in the number of components.

### Solution to Problem

In order to achieve the above-described objects, the present disclosure has employed the following aspects.

(1) According to one aspect of the present disclosure, there is provided a control valve including: a casing having an inflow port through which a fluid flows in from an outside and an outflow port through which the fluid flows out to the outside; and a rotor having a bottomed tubular valve body forming an internal space through which the fluid flows, the rotor being accommodated inside the casing to be rotatable around an axis of the valve body, in which the rotor switches communication and cutoff between the internal space and at least one of the inflow port and the outflow port through a communication port formed in the valve body according to a rotation position of the valve body, and the casing includes an axial support portion configured to rotatably support the valve body via a bottom portion of the valve body, with the axial support portion in sliding contact with the bottom portion from an outer side of the valve body in an axial direction of the valve body.

According to the present aspect, the casing itself includes the axial support portion that rotatably supports the rotor, so that it is possible to achieve a reduction in the number of components as compared with a configuration in which the rotor is supported by a separate thrust bearing or the like. Moreover, the bottom portion of the valve body is supported by the axial support portion, so that it is possible to achieve a reduction in diameter of a shaft portion of the rotor as compared with a case where a stepped surface for a thrust bearing is formed on the shaft portion, for example. It is possible to achieve a reduction in size of the casing as compared with a case where a location for holding a separate thrust bearing is provided in the casing. As a result, it is possible to achieve a reduction in size of the control valve.

(2) In the aspect (1), it is preferable that the axial support portion continuously extends over an entire circumference around the axis.

According to the present aspect, it is easier to stably support the rotor inside the casing, and it is possible to suppress swinging, unbalanced contact, or the like of the rotor. It is possible to suppress a contaminant or the like entering to the inner side in the radial direction with respect to the axial support portion through a space between the axial support portion and the rotor (bottom portion), and the like.

(3) In the aspect (1), it is preferable that the axial support portion is intermittently provided around the axis.

According to the present aspect, it is possible to reduce the contact area between the axial support portion and the bottom portion, so that it is possible to suppress wear between the axial support portion and the bottom portion.

(4) In any one of the aspects (1) to (3), it is preferable that a sunken portion sunken in the axial direction with respect to the axial support portion is formed in a portion of the casing that is located on an outer side in a radial direction with respect to the axial support portion.

According to the present aspect, in the casing, a sedimentation region of the fluid can be formed in an outer region in the radial direction with respect to the axial support portion. Consequently, the contaminant or the like contained in the fluid can be captured before entering a space between the axial support portion and the bottom portion. As a result, it is possible to suppress the contaminant or the like entering a seal accommodating portion through a space between the axial support portion and the rotor (bottom portion), and the like.

(5) In any one of the aspects (1) to (4), it is preferable that the casing includes a casing main body in which the inflow port and the outflow port are formed, and an inflow joint connected to an opening end face of the inflow port of the casing main body, 5 and the axial support portion is integrally formed with the casing main body.

According to the present aspect, for example, a degree of freedom in design of the axial support portion can be improved as compared with a case where the axial support portion is formed on a joint or the like. As a result, it is possible to form the axial support portion at a desired position with a desired shape, and it is easier to stably support the rotor inside the casing.

(6) In any one of the aspects (1) to (5), it is preferable that the casing includes a radial support portion configured to rotatably support a tubular portion of the valve body from an inner side in a radial direction, with the radial support portion entering the internal space through an opening portion of the valve body. 15

According to the present aspect, the casing itself includes the radial support portion that rotatably supports the rotor, so that it is possible to achieve a reduction in the number of components as compared with a configuration in which a sliding bearing is provided between the rotor and the casing as in the related art, and the like. Moreover, 20 the valve body is rotatably supported by the radial support portion from the inner side in the radial direction, so that it is possible for the control valve to achieve a reduction in size, particularly in the radial direction, as compared with a configuration in which the valve body is rotatably supported from the outer side in the radial direction.

The valve body is supported from the inner side in the radial direction, so that the radial distance from a contact point between the radial support portion and an inner peripheral surface of the valve body to the axis can be shortened as compared with a case where the valve body is supported from the outer side in the radial direction. As a result, the peripheral speed on the inner peripheral surface of the valve body can be reduced, and wear at the contact point between the radial support portion and the inner peripheral surface of the valve body can be suppressed. By reducing torque acting on the contact point, it is possible to reduce the load on a drive unit that operates the rotor, so that the drive unit can be made smaller.

### Advantageous Effects of Invention

According to one aspect of the present disclosure, it is possible to achieve a reduction in size and a reduction in the number of components.

### BRIEF DESCRIPTION OF DRAWINGS

FIG. 1 is a block diagram of a cooling system according to an embodiment.

FIG. 2 is a perspective view of a control valve according to the embodiment.

FIG. 3 is an exploded perspective view of the control valve according to the embodiment.

FIG. 4 is a cross-sectional view corresponding to line IV-IV of FIG. 2.

FIG. 5 is a cross-sectional view corresponding to line V-V of FIG. 4.

FIG. 6 is an enlarged cross-sectional view of a control valve according to a modification example.

### DESCRIPTION OF EMBODIMENTS

Next, an embodiment of the present disclosure will be described with reference to the drawings. In the embodiment and a modification example, which will be described below, corresponding configurations may be designated by the same reference numerals, and descriptions thereof may be omitted. In the following description, for example, expressions indicating relative or absolute dispositions such as “parallel”, “orthogonal”, “center”, and “coaxial” not only strictly represent such dispositions but also represent a state in which there is a relative displacement with angles and distances that allow for tolerances and achieve the same function. In the present embodiment, “facing each other” is not limited to a case where orthogonal directions (normal directions) of two surfaces coincide with each other but also includes a case where the orthogonal directions intersect each other.

### Cooling System 1

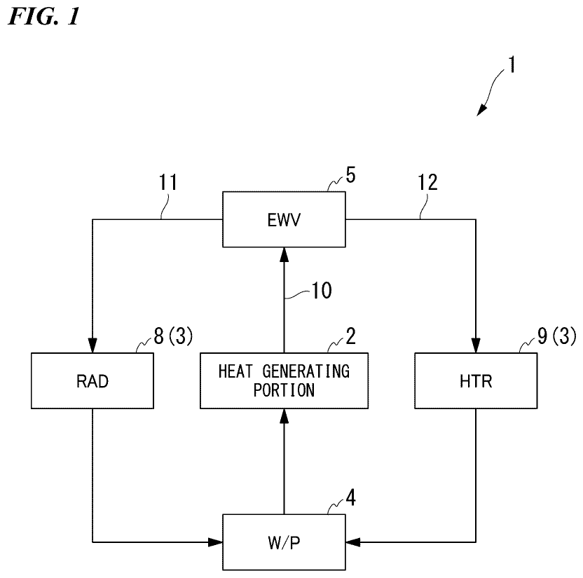

FIG. 1 is a block diagram of a cooling system 1.

As shown in FIG. 1, the cooling system 1 is mounted in, for example, a vehicle. In the present embodiment, the vehicle is not limited to a vehicle having an engine (internal combustion engine) as a vehicle drive source and may be an electrified vehicle. The electrified vehicle includes an electric vehicle, a hybrid vehicle, a plug-in hybrid vehicle, a fuel cell vehicle, and the like.

The cooling system 1 includes a heat generating portion 2, a heat dissipating portion 3, a water pump 4 (W/P), and a control valve 5 (EWV). In the cooling system 1, a cooling liquid circulates between the heat generating portion 2 and the heat dissipating portion 3 through the operations of the water pump 4 and the control valve 5.

The heat generating portion 2 is a component that serves as a cooling target (a heat absorbing target of the cooling liquid) of the cooling liquid, and is a drive source of the vehicle and other heat generating components. In a case of the electrified vehicle, the heat generating portion 2 includes, for example, a drive motor, a battery, a power conversion device, and the like.

The heat dissipating portion 3 is a component that serves as a heat dissipation target of the cooling liquid. In the present embodiment, the heat dissipating portion 3 includes a radiator 8 (RAD) and a heater core 9 (HTR). As the heat dissipating portion 3, a member can be appropriately selected as long as its temperature during normal operation is lower than the temperature of the cooling liquid after passing through the heat generating portion 2. As such a component, the heat dissipating portion 3 may be, for example, an EGR cooler that performs heat exchange between an EGR gas and the cooling liquid, a heat exchanger that performs heat exchange between a lubricating oil and the cooling liquid, or the like.

The water pump 4, the heat generating portion 2, and the control valve 5 are sequentially connected from upstream to downstream on a main flow path 10. In the main flow path 10, the cooling liquid sequentially passes through the heat generating portion 2 and the control valve 5 through the operation of the water pump 4.

A radiator flow path 11 and an air conditioning flow path 12 are each connected to the main flow path 10.

The radiator 8 is provided on the radiator flow path 11. The radiator flow path 11 is connected to the control valve 5 at a portion located upstream of the radiator 8. The radiator flow path 11 is connected to the heat generating portion 2 at a portion located downstream of the radiator 8. In the radiator flow path 11, heat exchange between the cooling liquid and outside air is performed in the radiator 8.

The heater core 9 is provided on the air conditioning flow path 12. The air conditioning flow path 12 is connected to the control valve 5 at a portion located upstream of the heater core 9. The air conditioning flow path 12 is connected to the heat generating portion 2 at a portion located downstream of the heater core 9. The heater core 9 is provided, for example, in a duct (not shown) of an air conditioner. In the air conditioning flow path 12, heat exchange between the cooling liquid and air conditioning air flowing inside the duct is performed in the heater core 9.

In the cooling system 1, the cooling liquid that has flowed into the control valve 5 through the operation of the water pump 4 is selectively supplied to at least any of the heat dissipating portions 3 by the operation of the control valve 5. The cooling liquid supplied to the heat dissipating portion 3 is heat-exchanged with the heat dissipating portion 3 in the process of passing through the heat dissipating portion 3. As a result, the cooling liquid is cooled by the heat dissipating portion 3. The cooling liquid that has passed through the heat dissipating portion 3 is supplied to the heat generating portion 2, and then is heat-exchanged with the heat generating portion 2 in the process of passing through the heat generating portion 2. Consequently, the heat generating portion 2 is cooled by the cooling liquid. As described above, in the cooling system 1, the heat generating portion 2 is cooled by the cooling liquid while the cooling liquid is cooled by the heat dissipating portion 3 in the process of circulating the cooling liquid between the heat generating portion 2 and the heat dissipating portion 3. As a result, in the cooling system 1, the heat generating portion 2 can be controlled to be a desired temperature.

### <Control Valve 5>

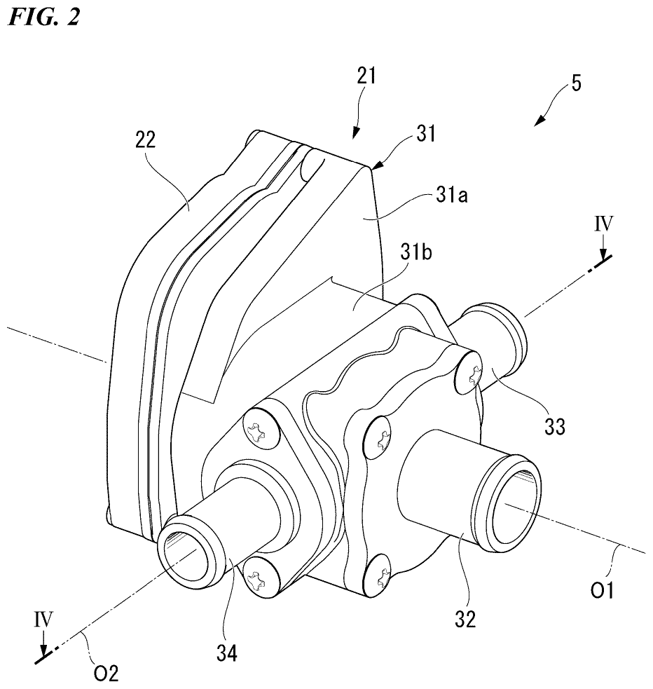

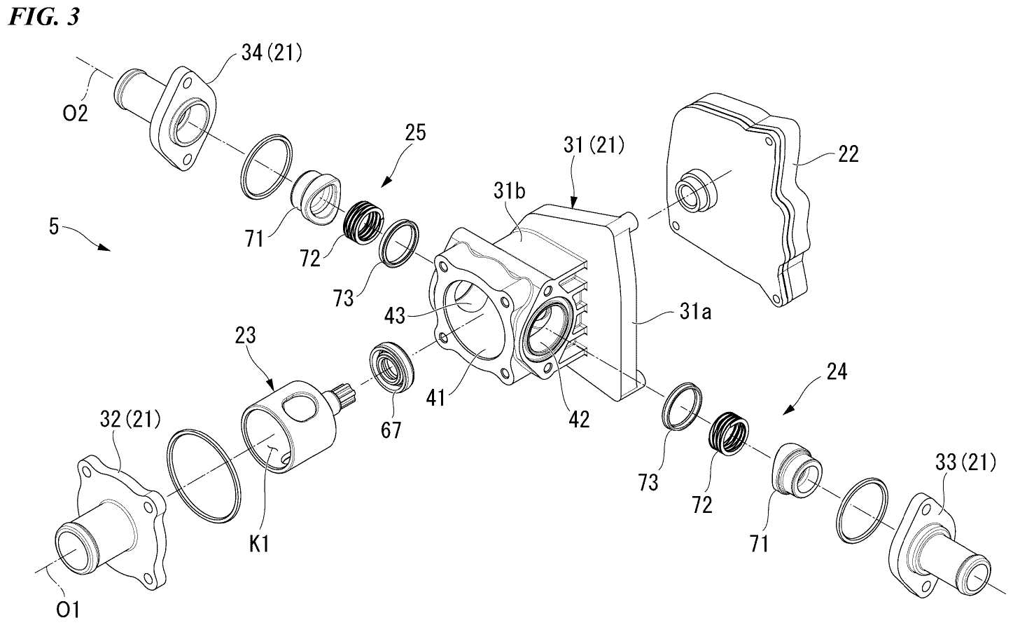

FIG. 2 is a perspective view of the control valve 5. FIG. 3 is an exploded perspective view of the control valve 5.

As shown in FIGS. 2 and 3, the control valve 5 includes a casing 21, a drive unit 22, a rotor 23, and a sealing mechanism (a first sealing mechanism 24 and a second sealing mechanism 25).

### <Casing 21>

The casing 21 includes a casing main body 31, an inflow joint 32, a first outflow joint 33, and a second outflow joint 34.

The casing main body 31 is formed in a bottomed tubular shape having a bottom wall part 31a and a peripheral wall part 31b. In the following description, a direction along an axis O1 of the casing main body 31 will be simply referred to as an axial direction. In the axial direction, an inflow joint 32 side with respect to the casing main body 31 will be referred to as a first side, and a side opposite to the first side will be referred to as a second side. A direction intersecting the axis O1 when viewed from the axial direction will be referred to as a radial direction, and a direction around the axis O1 will be referred to as a circumferential direction.

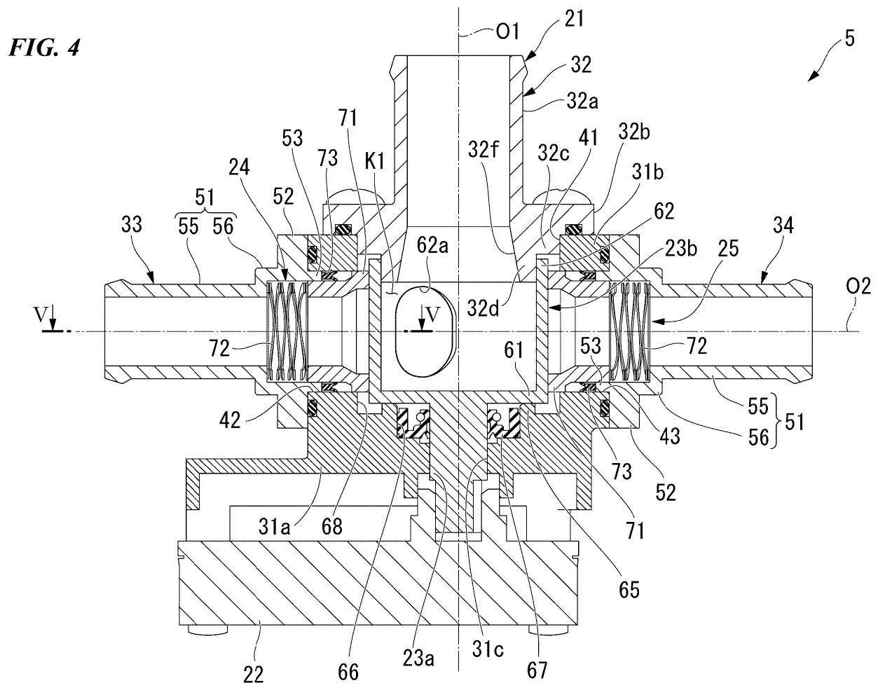

FIG. 4 is a cross-sectional view corresponding to line IV-IV of FIG. 2.

As shown in FIG. 4, the bottom wall part 31a is formed to have a size such that it projects to the outer side in the radial direction from the peripheral wall part 31b. A through hole 31c penetrating the bottom wall part 31a in the axial direction is formed in a portion of the bottom wall part 31a that is located on the axis O1.

In the casing main body 31, an inflow port 41 and a plurality of outflow ports (a first outflow port 42 and a second outflow port 43) are formed in the peripheral wall part 31b.

The inflow port 41 is an opening portion of the peripheral wall part 31b that faces the first side in the axial direction.

Each of the outflow ports 42 and 43 penetrates the peripheral wall part 31b in the radial direction. The outflow ports 42 and 43 are formed on the same circumference (at the same position in the axial direction) at an interval in the circumferential direction. In the present embodiment, the outflow ports 42 and 43 are formed at an equal interval in the circumferential direction. Therefore, in the shown example, an opening direction of the inflow port 41 and an opening direction of the first outflow port 42 are orthogonal to each other. The opening direction of the inflow port 41 and the opening direction of the second outflow port 43 are orthogonal to each other. The number of outflow ports may be singular or three or more. In a case where a plurality of outflow ports are provided, it is preferable that the outflow ports are provided at equal intervals in the circumferential direction.

The inflow joint 32 is attached to an opening end face of the inflow port 41. The inflow joint 32 connects the main flow path 10 and the control valve 5 to each other. The inflow joint 32 includes a joint tubular portion 32a, a flange portion 32b, a positioning tubular portion 32c, and a radial support portion 32d.

The joint tubular portion 32a extends coaxially with the axis O1. The joint tubular portion 32a is disposed in a state of protruding to the first side in the axial direction with respect to the opening end face of the inflow port 41.

The flange portion 32b projects to the outer side in the radial direction from an axial second-side end part of the joint tubular portion 32a. The flange portion 32b is fixed to the casing main body 31 by a screw or the like in a state in which a gasket is sandwiched between the flange portion 32b and the opening end face of the inflow port 41. The inflow joint 32 (flange portion 32b) may be attached to the opening end face of the inflow port 41 by welding (for example, vibration welding or the like).

The positioning tubular portion 32c protrudes from the flange portion 32b toward the second side in the axial direction. The positioning tubular portion 32c is formed in a tubular shape coaxial with the axis O1. The positioning tubular portion 32c is inserted into the inflow port 41 (the peripheral wall part 31b). The positioning tubular portion 32c is disposed in the inflow port 41 in a state of being close to or in contact with an inner peripheral surface of the inflow port 41 from the inner side in the radial direction. As a result, the movement of the inflow joint 32 in the radial direction with respect to the casing main body 31 is restricted.

The radial support portion 32d protrudes from the positioning tubular portion 32c toward the second side in the axial direction. In the shown example, the radial support portion 32d protrudes to a position where the radial support portion 32d partially overlaps the outflow ports 42 and 43 in the axial direction. However, the protruding amount of the radial support portion 32d from the positioning tubular portion 32c can be appropriately changed.

The radial support portion 32d is formed in a tubular shape coaxial with the axis O1. That is, the radial support portion 32d continuously extends over the entire circumference in the circumferential direction. The radial support portion 32d is formed in a tapered shape with the inner diameter gradually increasing while extending from the first side toward the second side in the axial direction. The outer diameter of the radial support portion 32d is uniformly formed over the entire length in the axial direction. In the present embodiment, the outer diameter of the radial support portion 32d is larger than the outer diameter of the joint tubular portion 32a and is smaller than the outer diameter of the positioning tubular portion 32c. Therefore, a gap is provided in the radial direction between the inner peripheral surface of the peripheral wall part 31b and the outer peripheral surface of the radial support portion 32d. However, the outer diameter of the radial support portion 32d may not be uniform.

The inner peripheral surface of the radial support portion 32d is formed with an inclined surface 32f that extends toward the outer side in the radial direction while extending from the first side toward the second side in the axial direction. In the present embodiment, the inclined surface 32f is continuously formed in a range reaching the inner peripheral surface of the positioning tubular portion 32c. However, the inclined surface 32f may be formed only on the radial support portion 32d or may be formed up to the joint tubular portion 32a. In addition, the inner diameter of the radial support portion 32d may be uniform.

The first outflow joint 33 is attached to an opening end face of the first outflow port 42. The first outflow joint 33 connects, for example, the radiator 8 (radiator flow path 11) and the control valve 5 to each other. The first outflow joint 33 includes a joint tubular portion 51, a flange portion 52, and a positioning tubular portion 53.

The joint tubular portion 51 is disposed in a state of protruding to the outer side in the radial direction with respect to the opening end face of the first outflow port 42. In the following description, a direction along an axis O2 of the joint tubular portion 51 may be referred to as a joint axial direction, a direction intersecting the joint axial direction when viewed from the joint axial direction may be referred to as a joint radial direction, and a direction around the axis O2 may be referred to as a joint circumferential direction.

The joint tubular portion 51 is formed in a multi-stage tubular shape with the diameter decreasing while extending toward the outer side in the joint axial direction (in a direction away from the casing main body 31). The joint tubular portion 51 includes a small-diameter portion 55 and a large-diameter portion 56 that is contiguously formed on the inner side in the joint axial direction (in a direction approaching the casing main body 31) with respect to the small-diameter portion 55.

The flange portion 52 projects from the large-diameter portion 56 toward the outer side in the joint radial direction. The flange portion 52 is fixed to the casing main body 31 by a screw or the like in a state in which a gasket is sandwiched between the flange portion 52 and the opening end face of the first outflow port 42. The first outflow joint 33 (flange portion 52) may be attached to the opening end face of the first outflow port 42 by welding (for example, vibration welding or the like).

The positioning tubular portion 53 protrudes from an inner peripheral edge of the flange portion 52 toward the inner side in the joint axial direction. The positioning tubular portion 53 is formed in a tubular shape coaxial with the axis O2. The inner diameter of the positioning tubular portion 53 is the same as the inner diameter of the large-diameter portion 56. The positioning tubular portion 53 is inserted into the first outflow port 42. The positioning tubular portion 53 is disposed in the first outflow port 42 in a state of being close to or in contact with an inner peripheral surface of the first outflow port 42 from the inner side in the joint radial direction. As a result, the movement of the first outflow joint 33 in the joint radial direction with respect to the casing main body 31 is restricted.

The second outflow joint 34 is attached to an opening end face of the second outflow port 43. The second outflow joint 34 connects, for example, the heater core 9 (air conditioning flow path 12) and the control valve 5 to each other. The second outflow joint 34 has the same configurations as those of the first outflow joint 33. Therefore, the description of the second outflow joint 34 will be omitted by assigning the same reference numerals as those of the first outflow joint 33 to the configurations of the second outflow joint 34 that correspond to the first outflow joint 33.

### <Drive Unit 22>

The drive unit 22 is attached to the bottom wall part 31a. The drive unit 22 is configured with a motor, a deceleration mechanism, a control board, and the like (not shown), all housed therein.

### <Rotor 23>

The rotor 23 is accommodated inside the casing 21 to be rotatable around the axis O1. The rotor 23 includes a shaft portion 23a and a valve body 23b.

The shaft portion 23a is disposed coaxially with the axis O1. The shaft portion 23a penetrates the bottom wall part 31a through the through hole 31c. An axial second-side end part of the shaft portion 23a is coupled to the drive unit 22 outside the casing 21. As a result, the power of the drive unit 22 is transmitted to the rotor 23 via the shaft portion 23a.

The valve body 23b is open toward the first side in the axial direction and is formed in a bottomed tubular shape disposed coaxially with the axis O1. A space of the valve body 23b that is surrounded by a bottom portion 61 and a tubular portion 62 forms an internal space K1 of the valve body 23b. That is, the internal space K1 communicates with the inside of the casing 21 through an opening portion of the tubular portion 62 that faces the first side in the axial direction.

The bottom portion 61 of the valve body 23b projects from an axial first-side end part of the shaft portion 23a to the outer side in the radial direction.

The tubular portion 62 of the valve body 23b extends from an outer peripheral edge of the bottom portion 61 to the first side in the axial direction. The tubular portion 62 extends to the first side in the axial direction beyond the outflow ports 42 and 43.

A communication port 62a is formed in the tubular portion 62 at the same position in the axial direction as each of the outflow ports 42 and 43. The communication port 62a penetrates the tubular portion 62 in the radial direction. In a case where at least a part of the communication port 62a and at least a part of any one of the outflow ports 42 and 43 overlap each other when viewed from the radial direction, the valve body 23b allows the internal space K1 to communicate with the one of the outflow ports 42 and 43 through the communication port 62a. In the present embodiment, two communication ports 62a are formed at an interval in the circumferential direction. In the shown example, an angle on the obtuse angle side of the conjugate angle formed by a straight line connecting the axis O1 and each of the communication ports 62a is larger than 90° and smaller than 180°. However, the number of the communication ports 62a, the interval between the communication ports 62a adjacent to each other, and the like can be appropriately changed.

Here, the rotor 23 is rotatably accommodated inside the casing 21 in a state of being supported by the radial support portion 32d from the inner side in the radial direction in the tubular portion 62 and being supported by an axial support portion 65 from the second side in the axial direction in the bottom portion 61. The radial support portion 32d is inserted into the tubular portion 62 through the opening portion of the tubular portion 62 that faces the first side in the axial direction. The radial support portion 32d is close to or in contact with the inner peripheral surface of the tubular portion 62 from the inner side in the radial direction at an axial first-side end part of the tubular portion 62. As a result, the radial support portion 32d restricts the movement of the rotor 23 in the radial direction with respect to the casing 21. The radial support portion 32d rotatably supports the rotor 23 by sliding the inner peripheral surface of the tubular portion 62 with the rotation of the rotor 23. The amount of entry of the radial support portion 32d into the tubular portion 62 can be appropriately changed. In the shown example, the entry of the radial support portion 32d reaches a position where the radial support portion 32d partially overlaps the sealing mechanisms 24 and 25 (a sliding ring 71 which will be described below) without overlapping the communication port 62a when viewed from the radial direction.

The axial support portion 65 protrudes toward the first side in the axial direction from a portion of the bottom wall part 31a that overlaps the bottom portion 61 when viewed from the axial direction. The axial support portion 65 is disposed coaxially with the axis O1 and is formed in a tubular shape surrounding the periphery of the shaft portion 23a. That is, the axial support portion 65 continuously extends over the entire circumference in the circumferential direction.

An axial first-side end face of the axial support portion 65 is formed as a flat surface orthogonal to the axial direction. The axial support portion 65 is close to or in contact with an outer end face (the end face facing the second side in the axial direction) of the bottom portion 61 from the second side in the axial direction. Consequently, the axial support portion 65 restricts the movement of the rotor 23 to the second side in the axial direction with respect to the casing 21. The axial support portion 65 rotatably supports the rotor 23 by sliding the outer end face of the bottom portion 61 with the rotation of the rotor 23. It is preferable that the axial support portion 65 faces the outer end face of the bottom portion 61 at an outer peripheral portion of the outer end face. In the shown example, the axial support portion 65 is located on the outer side in the radial direction with respect to a location where the radius of the bottom portion 61 is divided in a 1:1 ratio, and faces the outer end face of the bottom portion 61 at a portion located on the inner side in the radial direction with respect to the inner peripheral surface of the tubular portion 62.

A seal accommodating portion 66 is formed in a portion of the bottom wall part 31a that is located on the inner side in the radial direction with respect to the axial support portion 65. The seal accommodating portion 66 is a recessed portion that is open toward the first side in the axial direction. The through hole 31c is open at a bottom surface of the seal accommodating portion 66. A lip seal 67 is fitted into the seal accommodating portion 66. The lip seal 67 is an annular member formed in a U-shape in a cross-sectional view. The lip seal 67 seals a space between the outer peripheral surface of the shaft portion 23a and an inner peripheral surface of the seal accommodating portion 66, inside the seal accommodating portion 66.

A sunken portion 68 is formed in a portion of the bottom wall part 31a that is located on the outer side in the radial direction with respect to the axial support portion 65. The sunken portion 68 forms a sedimentation region of the cooling liquid, thereby capturing contaminants and the like contained in the cooling liquid before entering the space between the axial support portion 65 and the bottom portion 61. The sunken portion 68 is formed in a groove shape that is sunken to the second side in the axial direction with respect to the axial support portion 65 and that extends over the entire circumference in the circumferential direction. A surface of an inner surface of the sunken portion 68 that faces the inner side in the radial direction is formed by the inner peripheral surface of the peripheral wall part 31b. Meanwhile, a surface of the inner surface of the sunken portion 68 that faces the outer side in the radial direction is formed by the outer peripheral surface of the axial support portion 65.

### <First Sealing Mechanism 24 and Second Sealing Mechanism 25>

The first sealing mechanism 24 is provided in a portion surrounded by the first outflow joint 33 and the first outflow port 42 and seals a space between the first outflow joint 33 and the valve body 23b (tubular portion 62). The second sealing mechanism 25 is provided in a portion surrounded by the second outflow joint 34 and the second outflow port 43 and seals a space between the second outflow joint 34 and the valve body 23b (tubular portion 62). Since the sealing mechanisms 24 and 25 have the same configuration, the first sealing mechanism 24 will be described as an example.

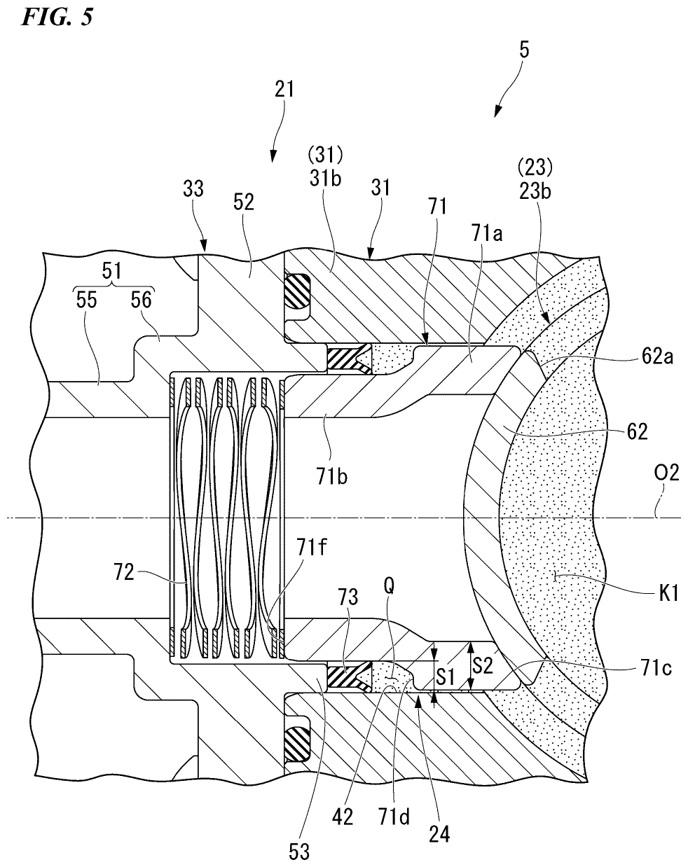

FIG. 5 is a cross-sectional view corresponding to line V-V of FIG. 4.

As shown in FIG. 5, the first sealing mechanism 24 includes the sliding ring 71, a biasing member 72, and a sealing ring 73.

The sliding ring 71 is inserted into the first outflow port 42. The sliding ring 71 is formed in a multi-stage tubular shape that extends coaxially with the axis O2 and that has a diameter which decreases while extending toward the outer side in the joint axial direction. The sliding ring 71 includes a large-diameter portion 71a and a small-diameter portion 71b that is contiguously formed from the large-diameter portion 71a to the outer side in the joint axial direction.

The large-diameter portion 71a is disposed in the first outflow port 42 in a state of being close to or in contact with the inner peripheral surface of the first outflow port 42 from the inner side in the joint radial direction. Consequently, the movement of the sliding ring 71 in the joint radial direction with respect to the casing main body 31 is restricted. An inner-side end face of the large-diameter portion 71a in the joint axial direction forms a sliding surface 71c. The sliding surface 71c is formed in an arc shape that extends to mimic the outer peripheral surface of the tubular portion 62 when viewed from the axial direction. The sliding surface 71c slides on the outer peripheral surface of the tubular portion 62 with the relative rotation between the rotor 23 and the sliding ring 71.

An outer peripheral surface of the small-diameter portion 71b is contiguous to an outer peripheral surface of the large-diameter portion 71a via a stepped surface 71d. The stepped surface 71d is inclined to the outer side in the joint radial direction while extending toward the inner side in the joint axial direction, and then, further extends to the outer side in the joint radial direction. Therefore, a gap in the joint radial direction (hereinafter, referred to as a seal gap Q) is provided between the outer peripheral surface of the small-diameter portion 71b and the inner peripheral surface of the first outflow port 42.

Meanwhile, an inner peripheral surface of the small-diameter portion 71b is smoothly contiguous to an inner peripheral surface of the large-diameter portion 71a. An outer-side end face (hereinafter, referred to as a seat surface 71f) of the small-diameter portion 71b in the joint axial direction is formed as a flat surface orthogonal to the joint axial direction. The seat surface 71f is disposed at the same position as the opening end face of the first outflow port 42 in the joint axial direction.

The biasing member 72 is disposed between the sliding ring 71 and the first outflow joint 33. The biasing member 72 is, for example, a wave spring. An inner end part of the biasing member 72 in the joint axial direction is in contact with the seat surface 71f. An outer end part of the biasing member 72 in the joint axial direction is in contact with a stepped surface between the small-diameter portion 55 and the large-diameter portion 56 of the first outflow joint 33. As a result, the biasing member 72 biases the sliding ring 71 toward the inner side in the joint axial direction (the outer peripheral surface of the tubular portion 62).

The sealing ring 73 is, for example, a Y-gasket. The sealing ring 73 surrounds the periphery of the sliding ring 71 (small-diameter portion 71b) in a state in which an opening portion (bifurcated portion) thereof faces the inner side in the joint axial direction. Tip parts of the bifurcated portion are in close contact with the outer peripheral surface of the small-diameter portion 71b and the inner peripheral surface of the first outflow port 42 in a state in which the sealing ring 73 is disposed inside the seal gap Q. In the seal gap Q, a hydraulic pressure of the casing 21 is introduced into an inner region in the joint axial direction with respect to the sealing ring 73 through a space between the inner peripheral surface of the first outflow port 42 and the sliding ring 71. In this case, the stepped surface 71d forms a pressure-receiving surface that faces the sliding surface 71c on the sliding ring 71 in the joint axial direction and that is pressed to the inner side in the joint axial direction by receiving the hydraulic pressure inside the casing 21.

Meanwhile, in the sliding ring 71, an area S1 of the stepped surface 71d and an area S2 of the sliding surface 71c are set to satisfy the following Expressions (1) and (2).

$$S 1 < S 2 \leq S 1 / k \qquad ( 1 )$$

$$α \leq k < 1 \qquad ( 2 )$$

k: The pressure reduction constant of the cooling liquid flowing through the minute gap between the sliding surface 71c and the tubular portion 62
α: The lower limit value of the pressure reduction constant determined by the physical properties of the cooling liquid

The area S1 of the stepped surface 71d and the area S2 of the sliding surface 71c mean areas when projected in the joint axial direction.

The α in Expression (2) is a standard value of the pressure reduction constant determined by factors such as the type of cooling liquid or a usage environment (for example, temperature). For example, under normal usage conditions, α=1/2 in a case of water. In a case where the physical properties of the cooling liquid to be used change, it changes to α=1/3 or the like.

In addition, the pressure reduction constant k in Expression (2) is α (for example, 1/2), which is the standard value of the pressure reduction constant, when the sliding surface 71c is uniformly in contact with the tubular portion 62 from an outer edge to an inner edge in the joint radial direction. However, due to manufacturing errors, assembly errors, or the like of the sliding ring 71, the gap between the outer peripheral portion of the sliding surface 71c and the tubular portion 62 may slightly increase with respect to the inner peripheral portion of the sliding surface 71c. In this case, the pressure reduction constant k in Expression (2) gradually approaches k=1.

In the present embodiment, assuming that there is a minute gap between the sliding surface 71c of the sliding ring 71 and the outer peripheral surface of the tubular portion 62 to allow sliding, a relationship between the areas S1 and S2 of the stepped surface 71d and the sliding surface 71c is determined by Expressions (1) and (2).

That is, the pressure of the cooling liquid inside the casing 21 acts on the stepped surface 71d as it is. On the other hand, the pressure of the cooling liquid inside the casing 21 does not act on the sliding surface 71c as it is. The pressure of the cooling liquid acts with a pressure decrease when the cooling liquid flows through the minute gap between the sliding surface 71c and the tubular portion 62 from the outer edge toward the inner edge in the joint radial direction. In this case, the pressure of the cooling liquid gradually decreases toward the inner side in the joint radial direction, and allows the sliding ring 71 to be pushed to the outer side in the joint axial direction.

As a result, a force obtained by multiplying the area S1 of the stepped surface 71d by a pressure P in the casing 21 acts on the stepped surface 71d as it is. Meanwhile, a force obtained by multiplying the area S2 of the sliding surface 71c by the pressure P and the pressure reduction constant k in the casing 21 acts on the sliding surface 71c.

As is clear from Expression (1), the areas S1 and S2 of the control valve 5 of the present embodiment are set to satisfy k×S2≤S1. For this reason, a relationship of P×k×S2≤P×S1 is also satisfied.

Therefore, a force F1 (F1=P×S1) in a pressing direction that acts on the stepped surface 71d of the sliding ring 71 increases equal to or larger than a force F2 (F2=P×k×S2) in a lifting direction that acts on the sliding surface 71c of the sliding ring 71. Accordingly, in the control valve 5 of the present embodiment, the space between the sliding ring 71 and the tubular portion 62 can be sealed only by the relationship of the pressure of the cooling liquid in the casing 21.

Meanwhile, in the present embodiment, the area S1 of the stepped surface 71d is smaller than the area S2 of the sliding surface 71c. For this reason, it is possible to suppress the sliding surface 71c from being pressed against the tubular portion 62 with an excessive force even when the pressure of the cooling liquid in the casing 21 increases. Therefore, in a case where the control valve 5 of the present embodiment is employed, it is possible to avoid an increase in size and an increase in output of the drive unit 22 that rotationally drives the rotor 23, and it is possible to suppress the early wear of the radial support portion 32d, the axial support portion 65, and the sliding ring 71.

As described above, in the present embodiment, the area S2 of the sliding surface 71c is set to be larger than the area S1 of the stepped surface 71d within a range in which the pressing force acting on the sliding ring 71 to the inner side in the joint axial direction does not fall below the lifting force acting on the sliding ring 71 to the outer side in the joint axial direction. Therefore, it is possible to seal the space between the sliding ring 71 and the tubular portion 62 while suppressing the sliding ring 71 from being pressed against the tubular portion 62 with an excessive force.

### Method of Operating Control Valve 5

Next, a method of operating the control valve 5 described above will be described.

As shown in FIG. 1, in the main flow path 10, the cooling liquid sent out by the water pump 4 is heat-exchanged in the heat generating portion 2 and then flows toward the control valve 5. As shown in FIG. 4, the cooling liquid that has passed through the heat generating portion 2 in the main flow path 10 flows into the internal space K1 through the inflow joint 32. The entire region inside the casing main body 31 is filled with the cooling liquid that has flowed into the internal space K1, through the communication port 62a, the gap between the rotor 23 and the inflow joint 32, and the like.

Subsequently, a method of distributing the cooling liquid in the control valve 5 will be described.

In a case where the communication port 62a and the outflow ports 42 and 43 do not overlap each other when viewed from the radial direction, the communication between the internal space K1 and the outflow ports 42 and 43 (the outflow joints 33 and 34) through the inside of the sliding ring 71 is cutoff (in a cutoff state). In the cutoff state, the flowing of the cooling liquid in the internal space K1 into the outflow ports 42 and 43 through the communication port 62a is restricted.

For example, in a case where the cooling liquid is to be supplied to the radiator 8, the communication between the communication port 62a and the first outflow port 42 is established. Specifically, the drive unit 22 is driven to rotate the rotor 23 around the axis O1. In this case, the rotor 23 rotates around the axis O1 while the sliding ring 71 (sliding surface 71c) slides on the outer peripheral surface of the tubular portion 62. Then, at least a part of the communication port 62a and at least a part of the inside of the sliding ring 71 overlap each other when viewed from the radial direction, so that the communication port 62a and the first outflow port 42 communicate with each other (in a communication state). In the communication state, the cooling liquid in the internal space K1 flows out through the communication port 62a. The cooling liquid that has flowed out from the internal space K1 passes through the first outflow port 42 through the inside of the sliding ring 71, thereby being distributed to the radiator flow path 11 through the inside of the first outflow joint 33. The cooling liquid distributed to the radiator flow path 11 passes through the radiator 8 and then is returned to the main flow path 10, and flows into the control valve 5 again.

On the other hand, in a case where the cooling liquid is to be supplied to the heater core 9, the communication between the communication port 62a and the second outflow port 43 is established in the same method as the above-described method. Consequently, the cooling liquid that has flowed out from the internal space K1 passes through the second outflow port 43 through the inside of the sliding ring 71, thereby being distributed to the air conditioning flow path 12 through the inside of the second outflow joint 34.

As described above, in the control valve 5 of the present embodiment, the communication and the cutoff between the internal space K1 and the outflow ports 42 and 43 through the communication port 62a are switched according to the rotation position of the rotor 23. As a result, the cooling liquid can be distributed to the desired flow path.

In addition, in the control valve 5 of the present embodiment, a configuration has been employed in which the casing 21 includes the axial support portion 65 that rotatably supports the rotor 23 via the bottom portion 61 of the valve body 23b, with the axial support portion 65 in sliding contact with the bottom portion 61 from the second side in the axial direction.

According to this configuration, the casing 21 itself includes the axial support portion 65 that rotatably supports the rotor 23, so that it is possible to achieve a reduction in the number of components as compared with a configuration in which the rotor 23 is supported by a separate thrust bearing or the like. Moreover, the bottom portion 61 of the valve body 23b is supported by the axial support portion 65, so that it is possible to achieve a reduction in diameter of the shaft portion 23a as compared with a case where a stepped surface for a thrust bearing is formed on the shaft portion, for example. It is possible to achieve a reduction in size of the casing 21 as compared with a case where a location for holding a separate thrust bearing is provided in the casing. As a result, it is possible to achieve a reduction in size of the control valve 5. By reducing the diameter of the shaft portion 23a, the radial distance from the contact point between the sliding portion (for example, the lip seal 67 or the inner peripheral surface of the through hole 31c) with the shaft portion 23a and the shaft portion 23a to the axis O1 can be shortened. As a result, the peripheral speed on the outer peripheral surface of the shaft portion 23a can be reduced, and wear at the contact point between the sliding portion with the shaft portion 23a and the shaft portion 23a can be suppressed. By reducing torque acting on the contact point, it is possible to reduce the load on the drive unit 22, so that the drive unit 22 can be made smaller.

In the control valve 5 of the present embodiment, a configuration has been employed in which the axial support portion 65 continuously extends over the entire circumference around the axis O1.

According to this configuration, it is easier to stably support the rotor 23 inside the casing 21, and it is possible to suppress swinging, unbalanced contact, or the like of the rotor 23. It is possible to suppress the contaminant or the like entering the seal accommodating portion 66 through the space between the axial support portion 65 and the rotor 23 (bottom portion 61), and the like.

In the control valve 5 of the present embodiment, a configuration has been employed in which a sunken portion 68 sunken in the axial direction with respect to the axial support portion 65 is formed in a portion of the casing 21 that is located on the outer side in the radial direction with respect to the axial support portion 65.

According to this configuration, in the casing 21, a sedimentation region of the cooling liquid can be formed in the outer region in the radial direction with respect to the axial support portion 65. Consequently, the contaminant or the like contained in the cooling liquid can be captured before entering the space between the axial support portion 65 and the bottom portion 61. As a result, it is possible to suppress the contaminant or the like entering the seal accommodating portion 66 through the space between the axial support portion 65 and the rotor 23 (bottom portion 61), and the like.

In the control valve 5 of the present embodiment, a configuration has been employed in which the axial support portion 65 is formed integrally with the casing main body 31.

According to this configuration, for example, a degree of freedom in design of the axial support portion 65 can be improved as compared with a case where the axial support portion 65 is formed on a joint or the like. As a result, it is possible to form the axial support portion 65 at a desired position with a desired shape, and it is easier to stably support the rotor 23 inside the casing 21.

In the control valve 5 of the present embodiment, a configuration has been employed in which the casing 21 includes the radial support portion 32d that rotatably supports the valve body 23b from the inner side in the radial direction, with the radial support portion 32d entering the internal space K1 through the opening portion of the valve body 23b that faces the first side in the axial direction.

According to this configuration, the casing 21 itself includes the radial support portion 32d that rotatably supports the rotor 23, so that it is possible to achieve a reduction in the number of components as compared with a configuration in which a sliding bearing is provided between the rotor and the casing as in the related art, and the like. Moreover, the rotor 23 is rotatably supported by the radial support portion 32d from the inner side in the radial direction, so that it is possible for the control valve 5 to achieve a reduction in size, particularly in the radial direction, as compared with a configuration in which the rotor is rotatably supported from the outer side in the radial direction.

The rotor 23 is supported from the inner side in the radial direction, so that the radial distance from the contact point between the radial support portion 32d and the inner peripheral surface of the tubular portion 62 to the axis O1 can be shortened as compared with a case where the rotor 23 is supported from the outer side in the radial direction. As a result, the peripheral speed on the inner peripheral surface of the tubular portion 62 can be reduced, and wear at the contact point between the radial support portion 32d and the inner peripheral surface of the tubular portion 62 can be suppressed. By reducing torque acting on the contact point, it is possible to reduce the load on the drive unit 22, so that the drive unit 22 can be made smaller.

### Modification Example

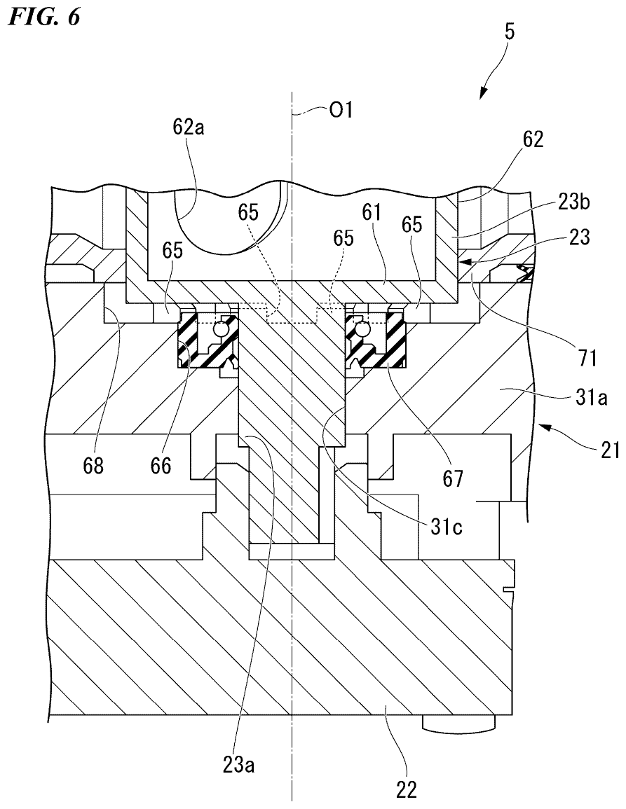

In the above-described embodiment, a configuration has been described in which the axial support portion 65 continuously extends over the entire circumference, but the present disclosure is not limited to this configuration. As in the control valve 5 shown in FIG. 6, the axial support portion 65 may be intermittently provided in the circumferential direction.

According to this configuration, it is possible to reduce the contact area between the axial support portion 65 and the bottom portion 61, so that it is possible to suppress wear between the axial support portion 65 and the bottom portion 61.

### Other Modification Examples

Although preferable embodiments of the present disclosure have been described above, the present disclosure is not limited to these embodiments. Additions, omissions, replacements, and other modifications in the configurations can be made within the scope that does not depart from the gist of the present disclosure. The present disclosure is not limited by the above description but is limited only by the appended claims.

For example, in the above-described embodiment, a configuration has been described in which the control valve 5 is mounted in the cooling system 1 of the vehicle, but the present disclosure is not limited to only this configuration, and the control valve 5 may be mounted in other systems.

In the above-described embodiment, a configuration has been described in which the cooling liquid that has flowed into the control valve 5 is distributed to the radiator flow path 11 and the air conditioning flow path 12, but the present disclosure is not limited to only this configuration. The control valve 5 need only have a configuration in which the cooling liquid flowing into the control valve 5 is distributed to a plurality of flow paths.

In the above-described embodiment, a configuration has been described in which the inflow port 41 faces the axial direction and the outflow ports 42 and 43 face the radial direction, but the present disclosure is not limited to this configuration. For example, a configuration in which the outflow ports face the axial direction and the inflow port faces the radial direction, or a configuration in which the inflow port and the outflow ports all face the axial direction or the radial direction may also be employed.

In addition, regarding the configuration in which the inflow port or the outflow ports face the radial direction, the inflow port or the outflow ports may be provided at different positions in the axial direction without being limited to the same circumference. In a case where the inflow port or the outflow ports are disposed unevenly in the circumferential direction, a boss or the like for supporting the rotor 23 (tubular portion 62) may be provided in a portion of the casing 21 that is located on the same circumference as the inflow port or the outflow ports. In this case, the inflow port, the outflow ports, or the boss disposed on the same circumference are disposed at equal intervals, so that it is easier to stably support the rotor 23 inside the casing 21, and it is possible to suppress swinging, unbalanced contact, or the like of the rotor 23.

In the above-described embodiment, a configuration has been described in which the opening portion of the casing main body 31 (peripheral wall part 31b) is made to function as the inflow port 41, but the present disclosure is not limited to this configuration. The inflow port or the outflow ports may be formed in the bottom wall part 31a of the casing main body 31. In this case, the communication port may be formed in the bottom portion 61 of the rotor 23.

In the above-described embodiment, a configuration has been described in which the inflow port 41 always communicates with the internal space K1, but the present disclosure is not limited to this configuration. For the inflow port 41, a configuration may also be employed in which the communication and the cutoff with the internal space K1 are switched in response to the rotation of the rotor 23. That is, the control valve according to the present disclosure need only have a configuration in which the communication and the cutoff between the internal space and at least one of the inflow port and the outflow port are switched through the communication port formed in the valve body according to the rotation position of the valve body.

In the above-described embodiment, a configuration has been described in which the axial support portion 65 protrudes in the axial direction from the bottom wall part 31a, but the present disclosure is not limited to this configuration. The axial support portion is formed on an inner surface of the casing 21, and then a protrusion portion that protrudes from the rotor 23 (for example, the bottom portion 61 or the tubular portion 62) toward the axial support portion and that slides on the axial support portion, or the like may be formed.

In the above-described embodiment, a configuration has been described in which the space between the rotor 23 and the outflow port is sealed via the sealing mechanism, but the present disclosure is not limited to this configuration. The space between the casing main body 31 and the rotor 23 may be sealed, for example, through the direct sliding between the inner peripheral surface of the casing main body 31 and the rotor 23 (tubular portion 62).

In the above-described embodiment, a configuration has been described in which the axial support portion 65 is integrally formed with the casing main body 31, but the present disclosure is not limited to this configuration. The axial support portion 65 may be integrally formed with the inflow joint 32 or the outflow joints 33 and 34.

In the above-described embodiment, a configuration has been described in which the radial support portion 32d is integrally formed with the casing 21, but the present disclosure is not limited to this configuration. In order to support the rotor 23 in the radial direction, a separate sliding bearing or the like from the casing 21 may be provided.

In the above-described embodiment, a case has been described in which the rotor 23 (tubular portion 62) and the casing 21 (peripheral wall part 31b) are each formed in a cylindrical shape (a uniform diameter over the entire axial direction), but the present disclosure is not limited to this configuration. That is, the outer diameter of the tubular portion 62 and the inner diameter of the peripheral wall part 31b may be changed in the axial direction as long as the tubular portion 62 is configured to rotate inside the peripheral wall part 31b. In this case, for example, the tubular portion 62 and the peripheral wall part 31b can employ various shapes such as a spherical shape (a shape whose diameter decreases while extending from the center part toward both end parts in the axial direction), a shape in which a plurality of spheres are contiguous to each other in the axial direction, a tapered shape (a shape whose diameter is gradually changed from the first side to the second side in the axial direction), and a stepped shape (a shape whose diameter is changed stepwise from the first side to the second side in the axial direction).

In addition, within the scope that does not depart from the gist of the present disclosure, it is possible to appropriately replace the constituent elements in the above-described embodiments with well-known constituent elements, and the above-described modification examples may be appropriately combined.

### REFERENCE SIGNS LIST

5: Control valve
21: Casing
23: Rotor
23b: Valve body
31: Casing main body
32: Inflow joint
32d: Radial support portion
41: Inflow port
42: First outflow port (outflow port)
43: Second outflow port (outflow port)
61: Bottom portion
62: Tubular portion
62a: Communication port
65: Axial support portion
68: Sunken portion
O1: Axis

1. A control valve comprising:
a casing having an inflow port through which a fluid flows in from an outside and an outflow port through which the fluid flows out to the outside; and
a rotor having a bottomed tubular valve body forming an internal space through which the fluid flows, the rotor being accommodated inside the casing to be rotatable around an axis of the valve body,
wherein the rotor switches communication and cutoff between the internal space and at least one of the inflow port and the outflow port through a communication port formed in the valve body according to a rotation position of the valve body, and
the casing includes an axial support portion configured to rotatably support the valve body via a bottom portion of the valve body, with the axial support portion in sliding contact with the bottom portion from an outer side of the valve body in an axial direction of the valve body.

2. The control valve according to claim 1,
wherein the axial support portion continuously extends over an entire circumference around the axis.

3. The control valve according to claim 1,
wherein the axial support portion is intermittently provided around the axis.

4. The control valve according to claim 1,
wherein a sunken portion sunken in the axial direction with respect to the axial support portion is formed in a portion of the casing that is located on an outer side in a radial direction with respect to the axial support portion.

5. The control valve according to claim 1,
wherein the casing includes
a casing main body in which the inflow port and the outflow port are formed, and
an inflow joint connected to an opening end face of the inflow port of the casing main body, and
the axial support portion is integrally formed with the casing main body.

6. The control valve according to claim 1,
wherein the casing includes a radial support portion configured to rotatably support a tubular portion of the valve body from an inner side in a radial direction, with the radial support portion entering the internal space through an opening portion of the valve body.
